(19) United States
(12) Patent Application Publication
(10) Pub. No.: US 2010/0235028 A1
(43) Pub. Date: Sep. 16, 2010

(54) TRAVELING APPARATUS AND METHOD OF CONTROLLING SAME

(76) Inventor: Shinji Ishii, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/667,699

(22) PCT Filed: Dec. 3, 2007
(86) PCT No.: PCT/JP2007/073738

§ 371 Date: Jan. 5, 2010

(51) Int. Cl. B60L 15/20

(52) U.S. Cl. 701/22

(57) ABSTRACT

To provides a traveling apparatus capable of being maintained at a standstill even on an inclined road surface, and a method of controlling the same. When the standstill switch SW is ON at the step S2, it reads the variation in the rotation angle of the tire from the time when the switch is turned on, and calculates the posture command correction angle θadj at step S4. Furthermore, it updates the posture command angle to the value expressed by the formula θREFpitch=θREFpitch0+θadj at step S5. Furthermore, When the standstill switch SW is OFF at the step S2, the posture command correction angle θadj is set to zero at step S6. Therefore, it becomes θREFpitch=θREFpitch0. Furthermore, it performs posture control calculation at step S7, and outputs a motor torque command Tref at step S8.

### TECHNICAL FIELD

The present invention relates to a traveling apparatus suitable for use in a vehicle in which, for example, two wheels each of which is independently driven are arranged in parallel and control is carried out such that the vehicle travels while being maintained stably in the front-and-back direction between the two wheels, and a method of controlling the same. In particular, it relates to an apparatus that does not make any accidental movement when it is parked in a slope or the like.

### BACKGROUND ART

In a traveling apparatus in the related art, the balance of a support platform with respect to a ground-contacting module is maintained by the motion of the ground-contacting module in response to the inclination of the support platform (for example, see Patent document 1).

Furthermore, there is another type of traveling apparatus in which posture control and traveling control are carried out by controlling and driving coaxially arranged left-and-right driving wheels in response to an output of a posture detection sensor in order to maintain the balance of the traveling apparatus in the front-and-back direction (for example, see Patent document 2).

However, neither of the above-mentioned two techniques can maintain the traveling apparatus at a standstill in an inclined road surface, and the traveling apparatus must increase the velocity in proportion to the angle of the inclination. Therefore, the traveling apparatus needs to be maintained at a standstill by the manual operation of the user in an inclined road surface. Furthermore, there is another problem that the traveling apparatus cannot maintain its posture autonomously in a slope when no person is riding on the traveling apparatus.

### [Patent Document 1]

### Japanese Patent Translation Publication No. 2004-500271

### [Patent Document 2]

### Japanese Unexamined Patent Application Publication No. 2004-074814

### DISCLOSURE OF THE INVENTION

### Problems to be Solved by the Invention

For example, the applicant of the present application previously proposed a traveling apparatus like the one described below as a vehicle traveling by two wheels with a person riding thereon (Japanese Patent Application No. 2005-117365). Firstly, one embodiment of the coaxial two-wheel vehicle proposed by the applicant of the present application is explained hereinafter with reference to FIGS. 7A and 7B.

As shown in FIGS. 7A and 7B, the coaxial two-wheel vehicle 10 that was previously proposed by the applicant has two wheels 11L and 11R arranged in parallel, and these two wheels 11L and 11R are independently driven by their respective motors 12L and 12R. Furthermore, the driving of these motors 12L and 12R is controlled by a control device 13. Furthermore, a posture sensor 14 composed of a gyroscope or the like is connected to the control device 13, and the control device 13 calculates drive torque (motor torque) necessary to control the motors 12L and 12R in accordance with a detection signal from the posture sensor 14.

Meanwhile, divided tables 15L and 15R are provided in the vicinity of the wheels 11L and 11R as one example of a getting-on portion on which a driver gets on. These divided tables 15L and 15R are maintained at specified postures with respect to each other by a link mechanism (not shown). Furthermore, a handle lever 16 is provided on and extends upward from a portion between the divided tables 15L and 15R, and a battery 17, which is used as the drive power supply for the whole portion of the apparatus, and a roll-axis angle detector 21 (see FIG. 8) are provided in the base part of that portion. Furthermore, grip portions 19 having a power switch 18 are provided on the upper portion of the handle lever 16.

Then, as shown in FIG. 8, the driver 20 stands up on the divided tables 15L and 15R by putting each of his/her feet on their respective divided tables 15L and 15R, grips the grip portions 19 on the upper portion of the handle lever 16, and manipulates the power switch 18 and the roll-axis angle of the handle lever 16. This manipulation is detected by the roll-axis angle detector 21. Furthermore, the position of the center-of-mass of the driver on the divided tables 15L and 15R is detected by an embedded pressure sensor (not shown). Furthermore, the detection signal from the posture sensor 14 shown in FIG. 7 is supplied to the control device 13 so that the traveling of the coaxial two-wheel vehicle 10 is controlled.

Furthermore, FIG. 9 shows a block diagram of the structure of a control system. That is, FIG. 9 shows the structure of the control system including the above-mentioned control device 13 and its peripheral circuits as a block diagram.

In FIG. 9, manipulation signals from various switches 30 are supplied to a central control device 31, and the central control device 31 generates left and right rotation angle command signals θref1 and θref2. These rotation angle command signals θref1 and θref2 are supplied to their respective motor control devices 32L and 32R. Furthermore, motor currents Im1 and Im2 generated in the motor control devices 32L and 32R are supplied to their respective motor 12L and 12R. Then, the rotations of these motor 12L and 12R are transferred to the wheels 11L and 11R through speed reducers 33L and 33R.

Meanwhile, the rotation angles of the motor 12L and 12R are detected by their respective detectors 34L and 34R. The detected rotation angle signals θm1 and θm2 are supplied to their respective motor control devices 32L and 32R as well as to the central control device 31, so that feedback control is carried out for the rotation angle command signal θref1 and θref2. Furthermore, detection signals from the pressure sensor 35 embedded in the divided tables 15L and 15R and from the roll-axis angle detector (PM) 21 are supplied to a circuit 36 including the posture sensor 14, and a roll-axis angle detection signal PM and generated table posture detection signals θ0 (including θroll, θpitch, θyaw, ωroll, ωpitch, and ωyaw) are supplied to the control device 13.

Furthermore, FIG. 10 is a schematic diagram of an illustrative structure of a control device for a one-wheel model. Note that the sensor will be shared between two tables in an actual two-wheel vehicle. Furthermore, control for the motor, which is linked to the wheel in the model shown in the figure, is carried out independently for each wheel by separate control devices.

In FIG. 10, pressure detection signals PS1, 2, 3, and 4 from a pressure sensor (not shown) embedded in a table 15 and a table posture detection signal θ0 from a posture sensor 14 composed of a gyro sensor and an acceleration sensor are supplied to a posture control portion 31 in a control device 13. Then, a rotation command θref is calculated by using these detection signals PS1-4 and θ0, and external table posture command signals θREFpitch, θREFyaw, ωREFpitch, and ωREFyaw originated from a passenger or the like, and the calculated rotation command θref is supplied to a motor control portion 32.

Furthermore, a motor 12 is connected to a wheel 11 through a speed reducer 33, and the motor 12 is equipped with a rotation angle detector 34. Then, a rotor rotation angular position signal θm from the rotation angle detector 34 is supplied to the motor control portion 32 in the control device 13. In this way, feedback control is carried out for the drive current to the motor 12 that is generated in accordance with the above-mentioned rotation command θref, and the driving of the wheel 11 is stabilized. In this manner, the wheel 11 is driven in a stable manner, and its driving is controlled by the detection signals PS1-4 from the pressure sensor (not shown), the detection signals θ0 from the posture sensor, and the like.

Furthermore, FIG. 11 shows the mutual connection relation of the system. In FIG. 11, the detection signals PS1-4 from a pressure sensor 35 and the roll-axis angle detection signal PM from a roll-axis angle detector (potentiometer) 21 are supplied to a posture sensor circuit 36. The posture sensor circuit 36 contains within it a gyro sensor 41 and an acceleration sensor 42. Therefore, the detection signals PS1-4, the roll-axis angle detection signal PM, and the table posture detection signal θ0 are taken out from the posture sensor circuit 36.

These detection signals PS1-4, the roll-axis angle detection signal PM, and the table posture detection signal θ0 are supplied to a central control device 43 in the control device 13. Furthermore, a manipulation signal from the power switch 18 is also supplied to the central control device 43. In this way, rotation commands θref1 and θref2 for left and right wheels are calculated in the central control device 43, and they are supplied to the motor control portions 32L and 32R. Furthermore, a signal from each of the rotation detectors 34L and 34R is supplied to their respective motor control portions 32L and 32R so that the motors 12L and 12R are driven.

Furthermore, electrical power from the battery 17 is supplied to a power supply circuit 44. From this power supply circuit 44, electrical power for 24 V motors, for example, is supplied to the motor control portions 32L and 32R, and electrical power for 5V control circuits, for example, is supplied to the posture sensor circuit 36 and the central control device 43. Note that the power supply circuit 44 is equipped with a power supply switch 45, so that electrical power supply to each portion is controlled. In this manner, the motors 12L and 12R are driven, and these motors 12L and 12R drive the wheels 11L and 11R, so that the driving of the coaxial two-wheel vehicle 10 is carried out.

The object of the present invention is a two-wheel vehicle having characteristic features that a motor is mounted into each independent wheel as shown in FIG. 7 and a control structure to maintain the balance by detecting the posture of the main body is adopted, wherein: the two-wheel vehicle has a traveling mechanism and a control device to carry out the traveling control by controlling the motor torque; a gyro sensor and an acceleration sensor is embedded in the base; and the vehicle is controlled such that the main body carries out forward movement, backward movement, and rotational traveling while maintaining base pitch angle and yaw angle at a stable posture determined by the control device by providing rotational torque to the wheels.

However, a vehicle having a characteristic feature that it has a degree of freedom in roll-axis rotation by a parallel link structure as shown in FIG. 7, or a vehicle that is also adaptable to one-wheel vehicles or vehicles having three or more wheels cannot be maintained at a standstill on an inclined road surface by the control method in which the vehicle is driven by using the principle of the inverted pendulum. Furthermore, the techniques described in the Patent documents 1 and 2 also cannot maintain the vehicle at a standstill on an inclined road surface, and the vehicle must increase the velocity in proportion to the angle of the inclination. Therefore, the vehicle needs to be maintained at a standstill by the manual operation of the user in an inclined road surface. In addition, there is another problem that the vehicle cannot maintain its posture autonomously in a slope when no person is riding on the vehicle.

The present invention has been made in view of such problems, and the problem to be solved by the present invention is that apparatuses in the related art cannot maintain the vehicles at a standstill on an inclined road surface. Furthermore, the techniques described in the Patent documents 1 and 2 also cannot maintain the vehicle at a standstill on an inclined road surface, and the vehicle must increase the velocity in proportion to the angle of the inclination. Therefore, the vehicle needs to be maintained at a standstill by the manual operation of the user in an inclined road surface. In addition, the vehicle has not been able to maintain its posture autonomously in a slope when no person is riding on the vehicle.

### Means for Solving the Problems

Therefore, in the present invention, control in which the control system for a servomotor has both of the control systems of control using an inverted pendulum and motor position control, and which can operate consistent with the braking by a brake lever has been invented. In this manner, it can autonomously maintain the posture and remain at a standstill regardless of the inclination of a road surface. Therefore, the present invention provides a traveling apparatus capable of being maintained at a standstill even on an inclined road surface, and a method of controlling the same.

### ADVANTAGEOUS EFFECTS OF THE INVENTION

The invention in claims 1, 2, and 3 enables to carry out control in which the control system for a servomotor has both of the control systems of control using an inverted pendulum and motor position control, and which can operate consistent with the braking by a brake lever, and therefore it can autonomously maintain the posture and remain at a standstill regardless of the inclination of a road surface.

Furthermore, the invention in claims 1 and 4 enables to carry out excellent control in a normal traveling mode. Furthermore, the invention in claims 1 and 5 enables to carry out excellent control when no person is on the vehicle.

Furthermore, the invention in claims 1 and 6 enables to carry out control such that the motor torque τ0 is balanced with the rotation torque τ1 of the wheel, so that it can autonomously maintain the posture and remain at a standstill regardless of the inclination of a road surface.

Furthermore, the invention in claims 7, 8, and 9 enables to realize a control method in which the control system for a servomotor has both of the control systems of control using an inverted pendulum and motor position control, and which can operate consistent with the braking by a brake lever, and therefore it can autonomously maintain the posture and remain at a standstill regardless of the inclination of a road surface.

Furthermore, the invention in claims 7 and 10 enables to realize a control method capable of carrying out excellent control in a normal traveling mode. Furthermore, the invention in claims 7 and 11 enables to realize a control method capable of carrying out excellent control when no person is on the vehicle.

Furthermore, the invention in claims 7 and 12 enables to realize a control method capable of carrying out control such that the motor torque τ0 is balanced with the rotation torque τ1 of the wheel, so that it can autonomously maintain the posture and remain at a standstill regardless of the inclination of a road surface.

As described above, apparatuses in the related art cannot maintain vehicles at a standstill on an inclined road surface. Furthermore, the techniques described in the Patent documents 1 and 2 also cannot maintain the vehicle at a standstill on an inclined road surface, and the vehicle must increase the velocity in proportion to the angle of the inclination. Therefore, the vehicle needs to be maintained at a standstill by the manual operation of the user in an inclined road surface. In addition, the vehicle has not been able to maintain its posture autonomously in a slope when no person is riding on the vehicle. The present invention can provide means capable of easily solving these problems.

### BRIEF DESCRIPTION OF THE DRAWINGS

FIG. 1 is a block diagram of one embodiment of a structure for standstill posture control to which a traveling apparatus and a control method in accordance with the present invention is applied;

FIG. 2 is a figure for illustrating it;

FIG. 3 is a figure for illustrating it;

FIG. 4 is a figure for illustrating it;

FIG. 5A is a figure for illustrating it;

FIG. 5B is a figure for illustrating it;

FIG. 6 is a flowchart for illustrating the operation of it;

FIG. 7A is a structural diagram showing one embodiment of a traveling apparatus to which the present invention is applied;

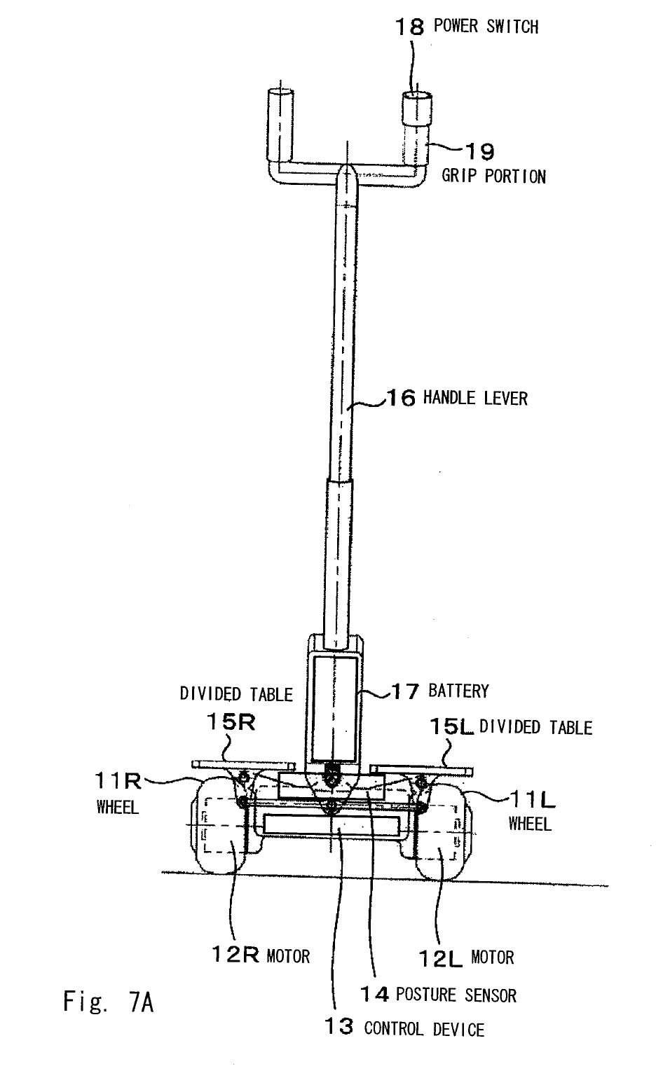

FIG. 7B is a structural diagram showing one embodiment of a traveling apparatus to which the present invention is applied;

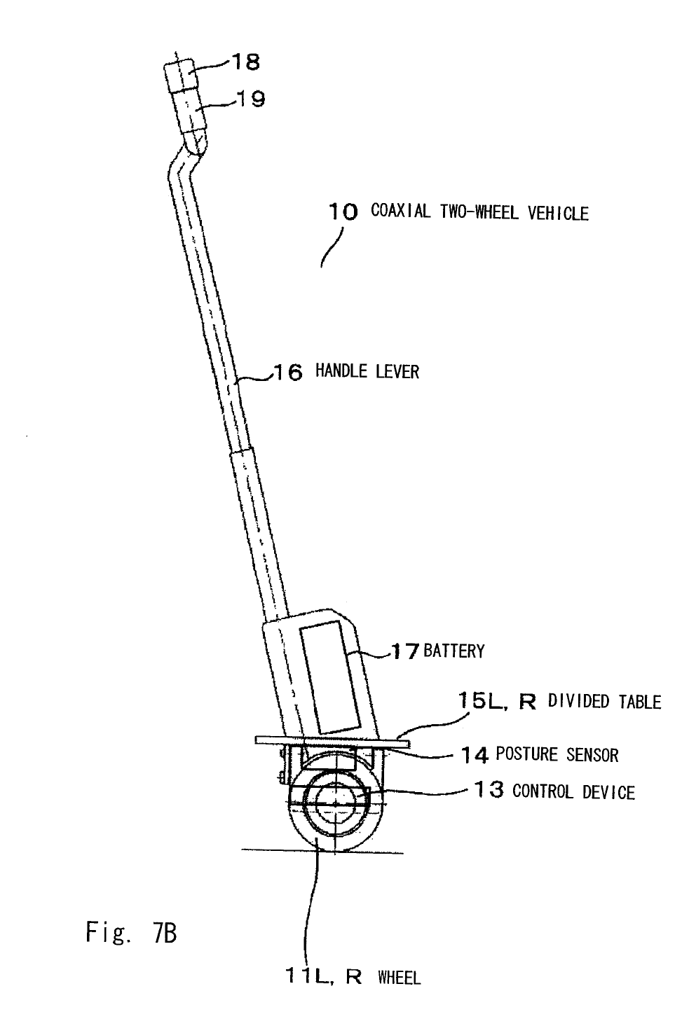

FIG. 8 is a figure for illustrating it;

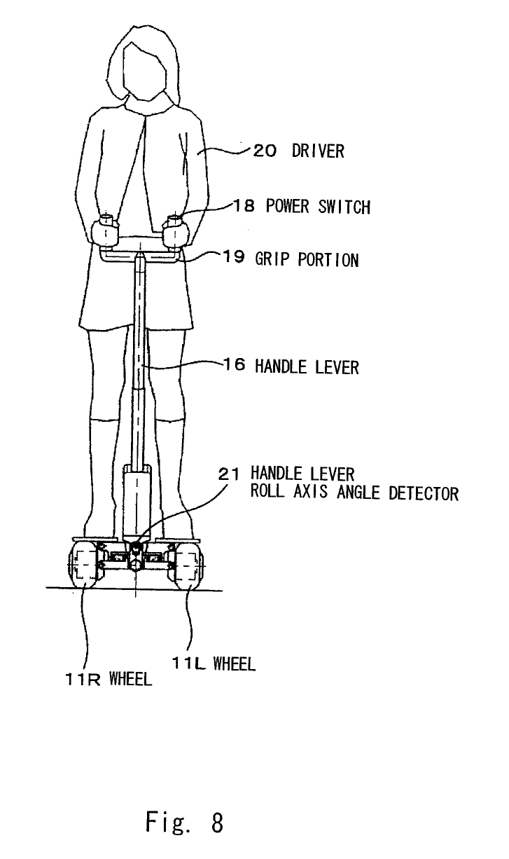

FIG. 9 is a figure for illustrating it;

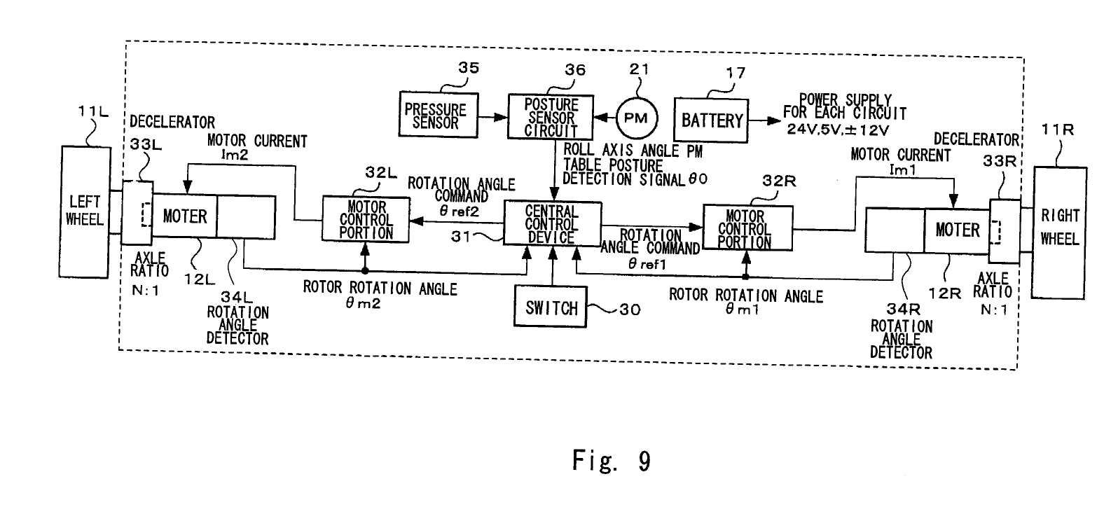

FIG. 10 is a figure for illustrating it; and

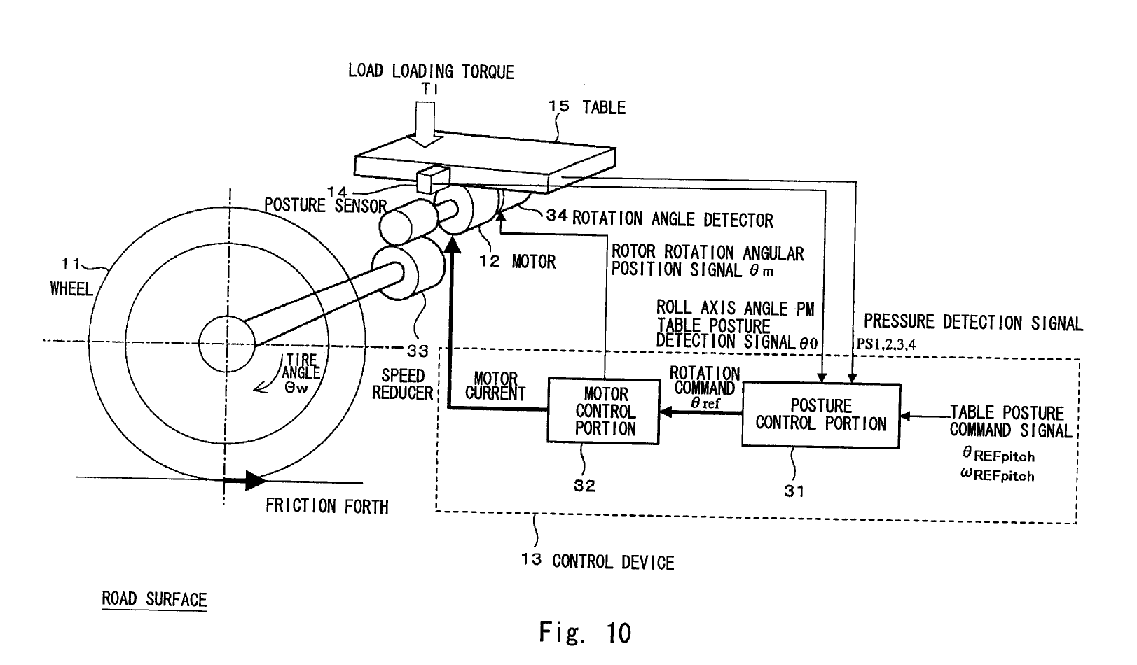

FIG. 11 is a figure for illustrating it;

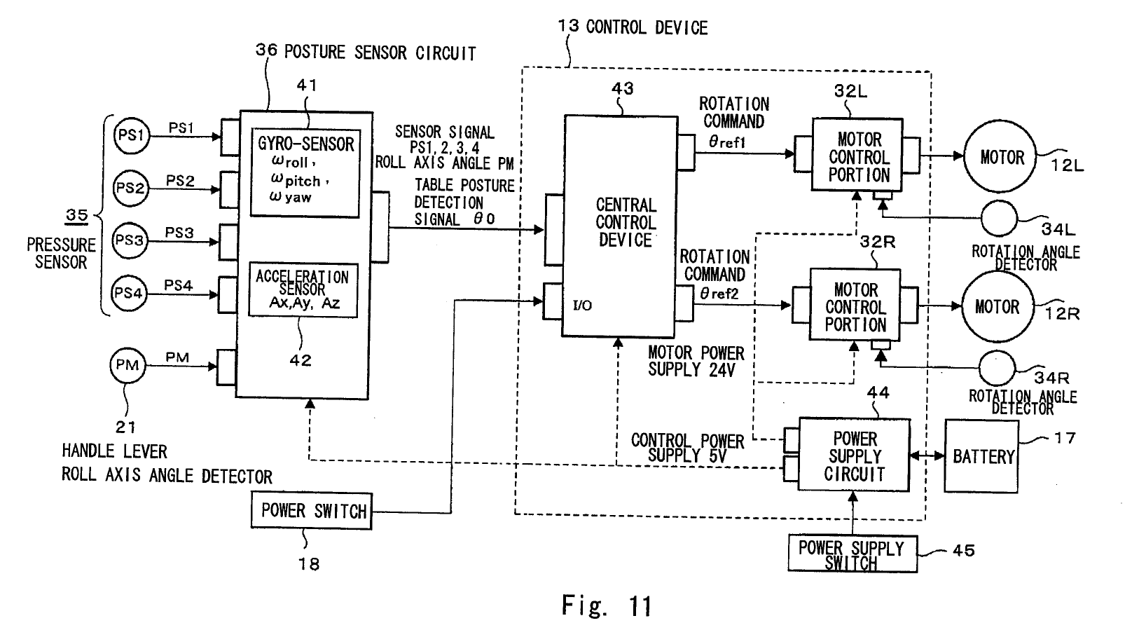

### DESCRIPTION OF REFERENCE NUMERALS

100 posture control calculation portion;
101 setting portion for stable posture angle command value
15 θREFpitch0;
102 setting portion for posture angular velocity command value ωREFpitch;
103, 106 adder;
104, 107 subtracter;
105, 108 controller;
109 amplifier having a gain Kamp;
110 motor constant (Km);
114 system;
119 calculation unit; and
120 switch.

### BEST MODES FOR CARRYING OUT THE INVENTION

That is, a traveling apparatus in accordance with the present invention to travel while controlling the driving of wheels includes: control means to generate a motor torque command signal by calculating motor torque necessary to drive the wheels; detection means to detect variation in the rotation angle of a wheel drive system driven by the generated motor torque command signal; posture command correction value calculation means to calculate posture command correction value from the variation in the rotation angle; manipulation means manipulated by a passenger to input a posture command angle; a select switch for a standstill mode; and decision means to determine the presence or absence of the passenger; wherein the control means calculates the motor torque in accordance with the posture command angle and the posture command correction value, and carries out, when the standstill mode is selected by the select switch, control in which the posture command correction value is added to the posture command angle.

Furthermore, a method of controlling a traveling apparatus that travels while controlling the driving of wheels in accordance with the present invention includes: generating a motor torque command signal by calculating motor torque in accordance with a supplied rotation command; detecting variation in the rotation angle of a wheel drive system driven by the generated motor torque command signal; calculating motor torque in accordance with a posture command angle inputted from manipulation means and a posture command correction value calculated from the variation in the rotation angle; and carrying out, when a standstill mode is selected, control in which the posture command correction value is added to the posture command angle.

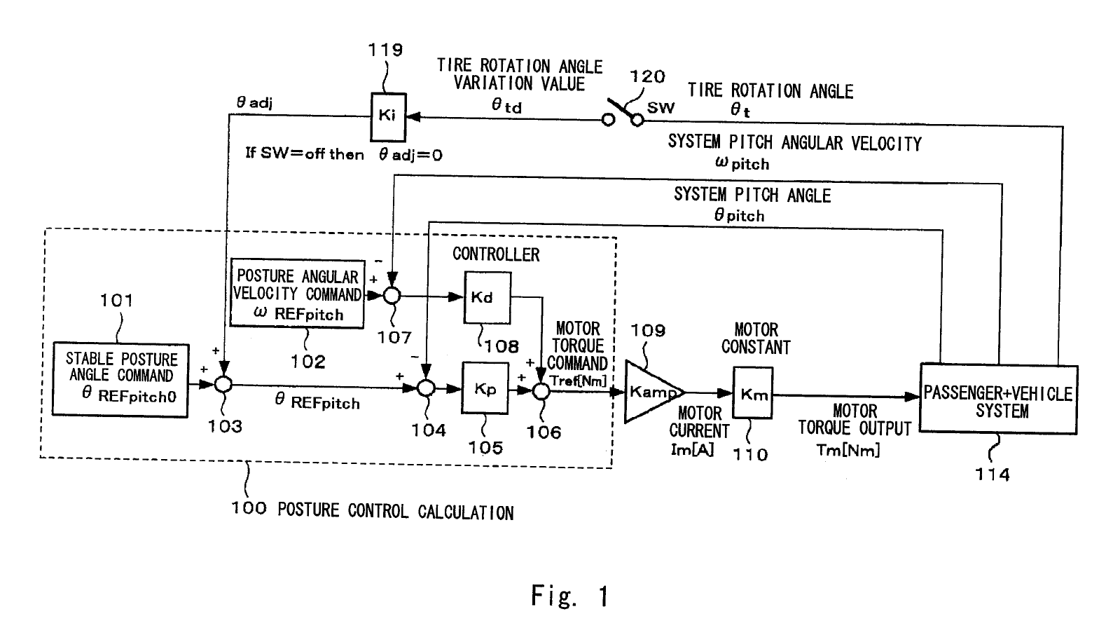

The present invention is explained hereinafter with reference to the drawings. FIG. 1 is a block diagram of one embodiment of a structure for standstill posture control to which a traveling apparatus and a control method in accordance with the present invention is applied.

In FIG. 1, a posture control calculation portion 100 has, for example, a setting portion for stable posture angle command value θREFpitch0 101 and a setting portion for posture angular velocity command value ωREFpitch 102. Then, the value θREFpitch0 from the setting portion 101 is supplied to a controller 105 through an adder 103 and a subtracter 104. Then, after multiplied by a coefficient Kp, it is supplied to an adder 106. Furthermore, the value ωREFpitch from the setting portion 102 is supplied to a controller 108 through a subtracter 107. Then, after multiplied by a coefficient Kd, it is supplied to the adder 106. In this manner, a motor torque command Tref [Nm] is taken out from the adder 106.

Furthermore, the motor torque command Tref[Nm] is supplied to an amplifier 109 having a gain Kamp and converted into a motor current Im[A], and then supplied to a motor. The motor is represented as a motor constant (Km) 110. In this manner, a motor torque output Tm[Nm] is taken out from the motor constant 110. The motor torque output Tm[Nm] is inputted to a system 114 composed of a passenger and a vehicle.

A table posture θ0 is detected in the system 114. Among the table posture θ0, a pitch velocity ωpitch is supplied to the subtracter 107 and subtracted from the value ωREFpitch, and a pitch angle θpitch is supplied to the subtracter 104 and subtracted from the value θREFpitch.

Furthermore, a tire rotation angle θt is also detected from the system 114.

The tire rotation angle θt is supplied to a calculation unit 119, and multiplied by Ki to generate a value θadj. The value θadj is supplied to the adder 103 through a switch 120, and added to the stable posture angle command value θREFpitch0 from the setting portion 101.

Accordingly, posture dynamics to maintain the balance in angular momentum, floor pressure, and the ZMP (Zero Moment Point) of two-wheel vehicle structure is explained hereinafter in regard to the structure for the above-described standstill posture control.

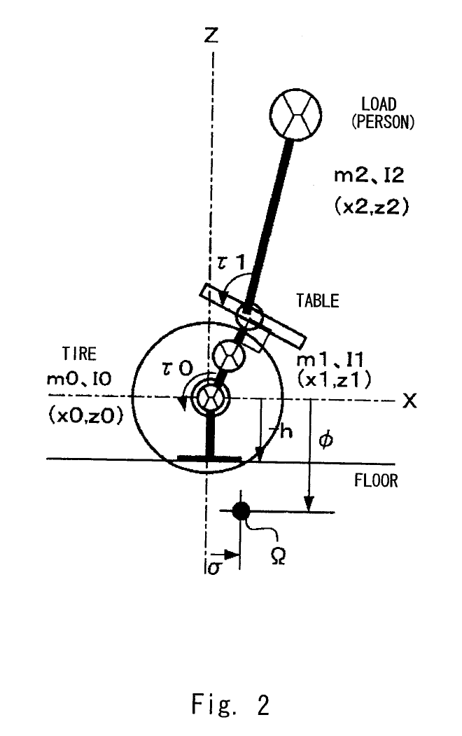

In the figure showing each point where force is applied as shown in FIG. 2, angular momentum on the defined point Ω(σ, φ) of the ith link can be calculated from the following Equation 1 where the center-of-mass coordinates of each link are represented by (xi, zi).

Ii*ωi+mi*xi(φ−zi)−mi*zi(σ−xi) [Equation 1]

Furthermore, the moment by the inertial force of all of the links is expressed by the following equation.

$${\sum }_{I = 0}^{n} ( Ii * \dot{ω} i + m i * \ddot{x} i ( φ - zi ) - m i * \ddot{z} i ( σ - xi ) ) \qquad [ Equation 2 ]$$

Next, the moment by the gravity of all of the links is expressed by the following equation.

$${\sum }_{I = 0}^{n} m i ( σ - xi ) g \qquad [ Equation 3 ]$$

Therefor, the moment on Ω is calculated by the sum of these moments, i.e., by the following Equation 4.

$$M Ω = {\sum }_{I = 0}^{n} Ii * \dot{ω} i + {\sum }_{i = 0}^{n} m i ( \ddot{x} i ( φ - zi ) - \ddot{z} i ( σ - xi ) ) + {\sum }_{i = 0}^{n} m i ( σ - xi ) g \qquad [ Equation 4 ]$$

Furthermore, if the moment by the gravity of the wheel having a weight m0 is excluded, the moment becomes the moment on the wheel axis. Letting Ma stand for this moment, the equation becomes the following equation.

$$Ma = {\sum }_{I = 0}^{n} Ii * \dot{ω} i + {\sum }_{i = 0}^{n} m i ( \ddot{z} i * xi - \ddot{x} i * zi ) - {\sum }_{i = 0}^{n} m i * xi * g \qquad [ Equation 5 ]$$

Furthermore, the moment MΩ on the above-mentioned Ω is expressed in the following equation by using Ma. That is, since X0=0, it is expressed by the following Equation 6.

$$M Ω = Ma - {\sum }_{I = 0}^{n} m i ( \ddot{z} i - g ) σ + {\sum }_{i = 0}^{n} m i * \ddot{x} i * φ \qquad [ Equation 6 ]$$

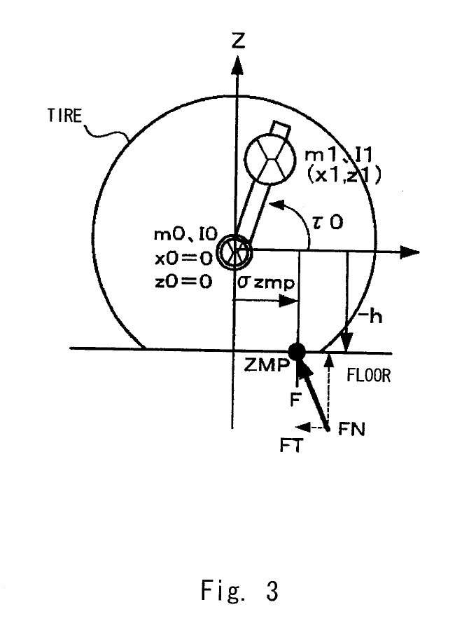

Meanwhile, as shown in FIG. 3, the ZMP is defined to be the point on the floor surface where the moment MΩ is zero. Letting h and (σzmp, −h) stand for the height of the wheel axis and the coordinates of the ZMP respectively, the following equation is obtained by substituting them into the Equation 4.

$$0 = {\sum }_{i = 0}^{n} Ii * \dot{ω} i + {\sum }_{i = 0}^{n} m i ( - \ddot{x} i ( h + zi ) - \ddot{z} i ( σ zmp - xi ) ) + {\sum }_{i = 0}^{n} m i ( σ zmp - xi ) g \qquad [ Equation 7 ]$$

By solving this equation for uzmp, the ZMP can be expressed by link positions, acceleration, and gravity. Furthermore, the following Equation 8 is obtained by substituting the coordinates of the ZMP into the Equation 6.

$$0 = Ma - {\sum }_{i = 0}^{n} m i ( \ddot{z} i - g ) σ zmp - {\sum }_{i = 0}^{n} m i * \ddot{x} i * h \qquad [ Equation 8 ]$$

At this point, the Equation 8 is an equation expressing the balance between the moments on the wheel axis. That is, F is the vector of the floor reactive forth and the rotational friction forth, FN is the floor reactive forth, and FT is the rotational friction forth. The reactive forth is expressed as a single point where the entire reactive forth acts on in the figure, although in reality the reactive forth is distributed over the bottom of the tire. The point of action expressed in such a manner is the ZMP.

By expressing the balance between the moments on the wheel axis point by using this equation, the following equation is obtained.

FN*σzmp+FT*h+τ0=0 [Equation 9]

Then, by substituting the following equation into this equation, the Equation 9 becomes the same equation as the Equation 8.

$$τ0 = Ma , \\ FN = - {\sum }_{i = 0}^{n} m i ( \ddot{z} i - g ) , \\ FT = - {\sum }_{i = 0}^{n} m i * \ddot{x} i \qquad [ Equation 10 ]$$

Meanwhile, only necessary condition to stabilize the posture above the axle is to have the Equation 9 satisfying σzmp=0. Therefore, if the equation τ0=−FT*h is satisfied, the posture is stably maintained. Accordingly, the posture can be stabilized by controlling the state variables of the Equation 11 so as to satisfy the condition τ0=FT=0.

$$( Xi , \dot{X} i , \ddot{X} i ) = ( 0 , 0 , 0 ) \qquad [ Equation 11 ]$$

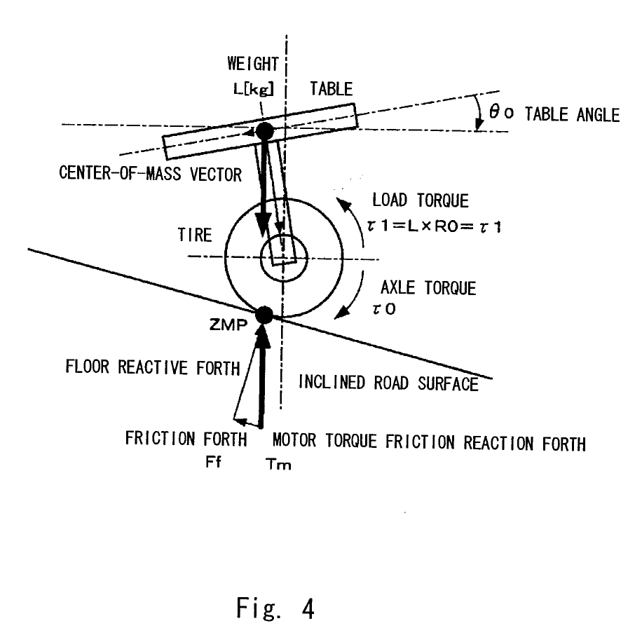

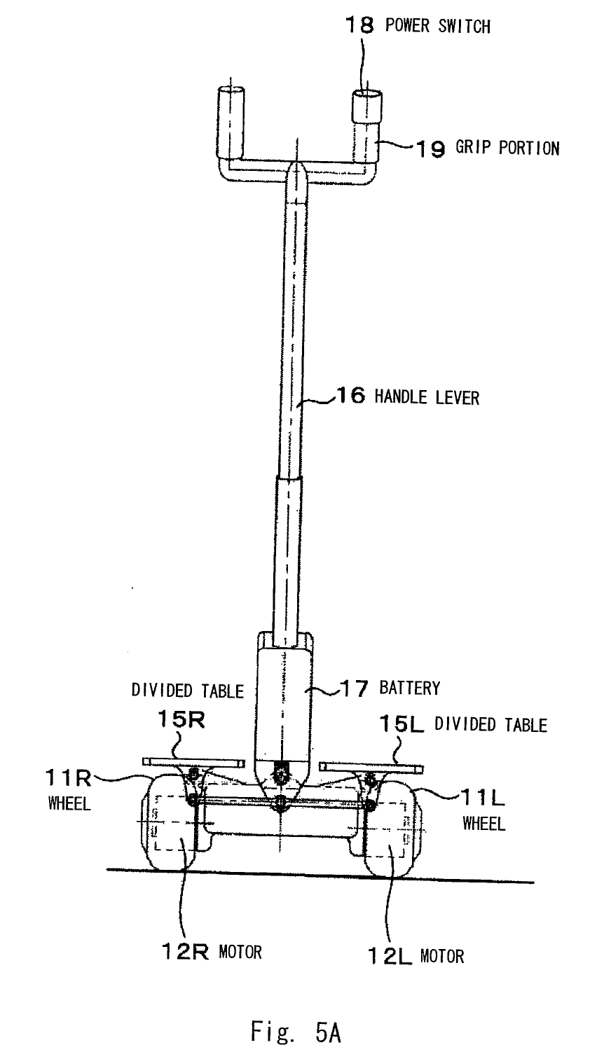

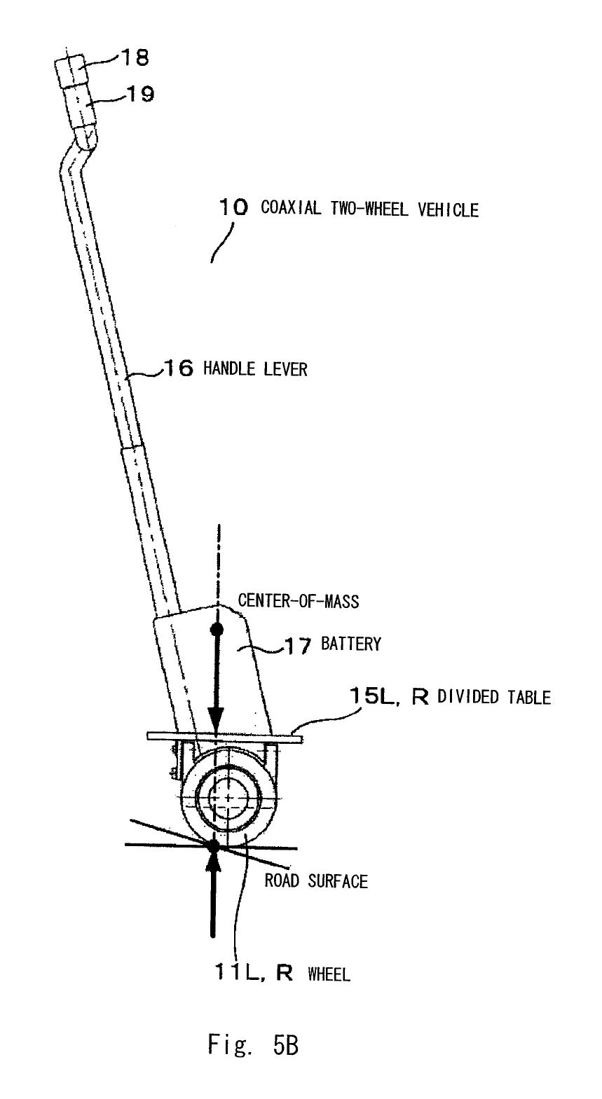

With the principle explained above, the ground touching point of the tire is located at the point shown in FIGS. 4 and 5 in an inclined road surface shown in the figures. To maintain the posture in a ground touching state like this, only necessary requirement is that the ZMP should have such a relation that the ZMP becomes the ground touching point of the tire. At this point, when it is inclined as shown in FIGS. 4 and 5, the posture can be maintained by adjusting the ZMP so as to become identical to the road surface touching point by motor torque τ0. Such motor drive torque is generated by the structure for the standstill posture control shown in FIG. 1.

That is, when the ground touching point of the tire is on the vector of the center-of-mass on an inclined road surface as shown in FIG. 4, this system can maintain the standstill posture. FIG. 5 shows a case where the system can keep the balance of an actual vehicle and maintain the standstill state on an inclined road surface by controlling the position of the center-of-mass to the ground touching point of the tire by using the control shown in FIG. 1.

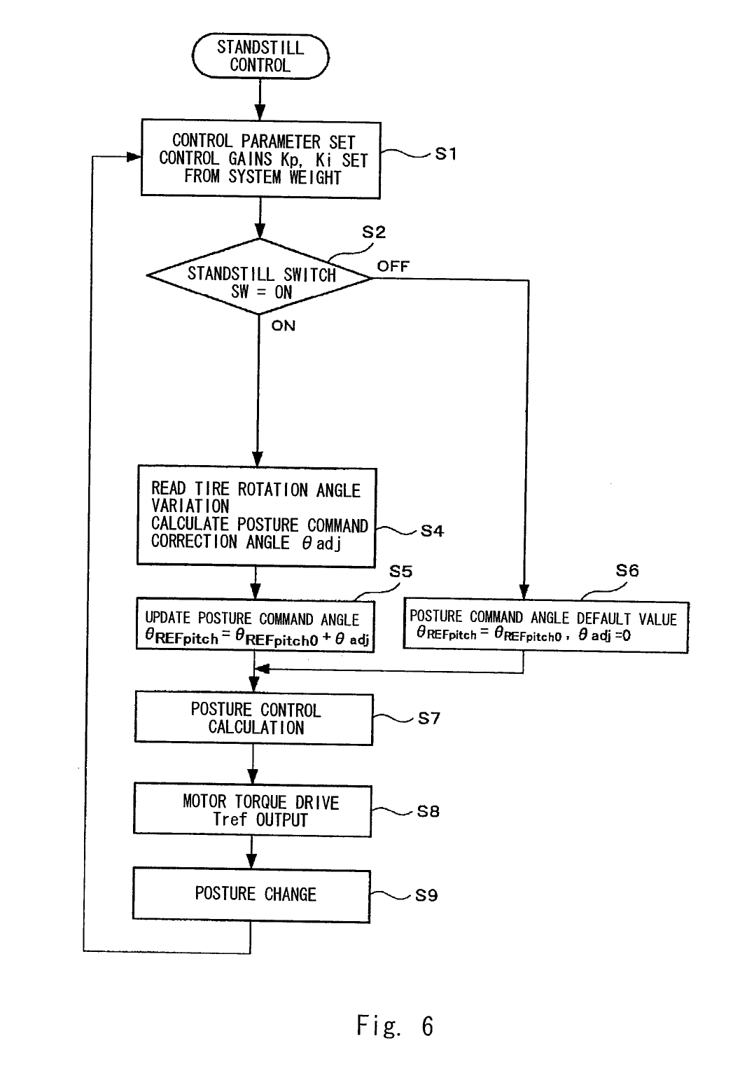

Furthermore, FIG. 6 shows a flowchart of the operation to carry out standstill control by using the control shown in FIG. 1. That is, in the standstill control shown in FIG. 6, control parameters are first established at step S1. At this step, control gains Kp, Ki are established depending on the system weight. Next, it determines whether a standstill switch SW120 is ON or not at step S2. That is, it determines whether the standstill control is selected or not.

When the standstill switch SW is ON at the step S2, it reads the variation in the rotation angle of the tire that is varied from the time when the switch is turned on, and calculates the posture command correction angle θadj at step S4. Furthermore, it updates the posture command angle to the value expressed by the formula θREFpitch=θREFpitch0+θadj at step S5.

Furthermore, when the standstill switch SW is OFF at the step S2, the posture command correction angle θadj is set to zero at step S6. Therefore, it becomes θREFpitch=θREFpitch0. Furthermore, it performs posture control calculation at step S7, and outputs a motor torque command Tref at step S8. Then, the posture is changed at step S9, and it returns to the step S1.

Accordingly, the control in which the control system for the servomotor has both of the control systems of control using an inverted pendulum and motor position control, and which can operate consistent with the braking by a brake lever is invented in the above-mentioned embodiment. In this manner, it can autonomously maintain the posture and remain at a standstill regardless of the inclination of a road surface. Therefore, the present invention can provide a traveling apparatus capable of being maintained at a standstill even on an inclined road surface, and a method of controlling the same.

Accordingly, in accordance with the present invention, a traveling apparatus to travel while controlling the driving of wheels includes: control means to generate a motor torque command signal by calculating motor torque necessary to drive the wheels; detection means to detect variation in the rotation angle of a wheel drive system driven by the generated motor torque command signal; posture command correction value calculation means to calculate posture command correction value from the variation in the rotation angle; manipulation means manipulated by a passenger to input a posture command angle; a select switch for a standstill mode; and decision means to determine the presence or absence of the passenger; wherein the control means calculates the motor torque in accordance with the posture command angle inputted from the manipulation means and the posture command correction value calculated by the posture command correction value calculation means, and carries out, when the standstill mode is selected by the select switch, control in which the posture command correction value is added to the posture command angle, so that the posture can be autonomously maintained and kept at a standstill regardless of the inclination of a road surface.

Furthermore, in accordance with the present invention, it enables to realize a method of controlling a traveling apparatus that travels while controlling the driving of wheels in accordance with the present invention including: generating a motor torque command signal by calculating motor torque in accordance with a supplied rotation command; detecting variation in the rotation angle of a wheel drive system driven by the generated motor torque command signal; calculating a posture command correction value from the variation in the rotation angle; calculating motor torque in accordance with a posture command angle inputted from manipulation means and the calculated posture command correction value; and carrying out, when a standstill mode is selected, control in which the posture command angle and the posture command correction value are added, so that the posture can be autonomously maintained and kept at a standstill regardless of the inclination of a road surface.

Note that the present invention is not limited to the embodiment explained in the above description, and various modifications can be made to the embodiments without departing from the spirit of the present invention.

1. A traveling apparatus to travel while controlling the driving of wheels, comprising:
a controller for generating a motor torque command signal by calculating motor torque necessary to drive the wheels;
a detector for detecting variation in the rotation angle of a wheel drive system driven by the generated motor torque command signal; and
a posture command correction value calculator for calculating posture command correction value from the variation in the rotation angle;
wherein the controller calculates the motor torque in accordance with a posture command angle and the posture command correction value.

2.-5. (canceled)

6. The traveling apparatus according to claim 1, wherein the controller carries out control such that the motor torque is balanced with the rotation torque of the wheels by adding the posture command correction value to the posture command angle.

7. A method of controlling a traveling apparatus that travels while controlling the driving of wheels, comprising:
generating a motor torque command signal by calculating motor torque in accordance with a supplied rotation command;
detecting variation in the rotation angle of a wheel drive system driven by the generated motor torque command signal;
calculating motor torque in accordance with a posture command angle and a posture command correction value calculated from the variation in the rotation angle; and
carrying out, when a standstill mode is selected, control in which the posture command correction value is added to the posture command angle.

8.-11. (canceled)

12. The method of controlling a traveling apparatus according to claim 7, wherein control is carried out such that the motor torque is balanced with the rotation torque of the wheels by adding the posture command correction value to the posture command angle.

13. The traveling apparatus according to claim 1, further comprising a manipulator for inputting the posture command angle.

14. The traveling apparatus according to claim 1, further comprising a select switch for a standstill mode,
wherein when the standstill mode is selected by the select switch, the controller carries out control to add the posture command correction value to the posture command angle.

15. The traveling apparatus according to claim 1, further comprising a select switch for a standstill mode,
wherein when the standstill mode is not selected by the select switch, the controller sets the posture command correction value to zero.

16. The method of controlling a traveling apparatus according to claim 6, wherein when the standstill mode is not selected, the posture command correction value is set to zero.
